(19) United States
(12) Patent Application Publication
(10) Pub. No.: US 2014/0026094 A1
(43) Pub. Date: Jan. 23, 2014

(54) SERVICE NOTIFICATION AND ALERT SYSTEM AND METHOD

(71) Applicants: Elizabeth A. Zimmerman, Shawnee, KS (US); Jaimie A. Macoubrie, Leawood, KS (US)

(72) Inventors: Elizabeth A. Zimmerman, Shawnee, KS (US); Jaimie A. Macoubrie, Leawood, KS (US)

(21) Appl. No.: 13/839,773

(22) Filed: Mar. 15, 2013

Related U.S. Application Data
(60) Provisional application No. 61/672,954, filed on Jul. 18, 2012.

(51) Int. Cl. G06F 3/0481

(52) U.S. Cl. CPC G06F 3/0481
USPC 715/781

(57) ABSTRACT

A system and method of notifying a homeowner of a more precise timeframe for real estate showings, service visits, or deliveries to a home or office. The system employs a pre-established list which includes all of the locations that must be visited in a day. Instead of providing the homeowner with a multi-hour window of when their residence may be visited, the system will provide the homeowner with updates based upon the GPS location and a location servicing program of the real estate agent, service worker, or delivery person. The system determines which addresses have been visited based upon the GPS coordinates of the agent's mobile computing device and proximity settings which in turn provides this information to homeowners.

### CROSS-REFERENCE TO RELATED APPLICATION

This application claims priority in U.S. provisional patent application Ser. No. 61/672,954, filed Jul. 18, 2012, which is incorporated herein by reference.

### BACKGROUND OF THE INVENTION

1. Field of the Invention

The present invention relates generally to a system and method for providing notifications and alerts to homeowners, and more specifically to a system and method for notifying home owners when service providers, real estate agents, or delivery persons are en route to, arriving at, and departing from the owner's home.

2. Description of the Related Art

When a real estate owner hires an agent to sell their property, there are many legal documents and formalities that occur. And, although it's not a requirement, one of the formalities is often the employment of a Showing Service. The Showing Service is a third-party that organizes and assists with the scheduling of the property showings for both the seller's and buyer's agent and prospective buyer. The buyer's agent contacts the Showing Service and details which showings within the Multiple Listing Service their prospective buyer wishes to tour on that particular day. The buyer's agent also provides the Showing Service with a very general and broad time frame for which they may arrive at each of the available listings. A two hour window for each listing is the standard allotted time for this potential showing.

This scenario presents inefficiencies and severe inconveniences for the home owner. Generally, the seller is requested to leave their home during the proposed two hour window. This is very inconvenient and burdensome for the homeowner. Not knowing if your home is the first or last to be viewed causes you to leave your home early and typically arrive past the 2 hour window. When a family has children and pets, or previous appointments at their home, and just dealing with normal family affairs each day at home, being required to leave one's home for two hours is very inconvenient and proven to be a waste of gas and money as they are trying to fill the gap in time by typically driving around town. And if one considers that a potential buyer and their agent may be running late, or they may drive by and with only viewing the exterior, they may not be interested and decide not to enter the home, which presents more needless inconveniences. We have a solution to minimize these needless burdens.

The same or similar issues occur with delivery drivers and service technicians. Homeowners are provided a window when the service provider will be visiting the home, or when a delivery will be made, and the owner will have to take off work or avoid performing other necessary tasks during the entire window.

What is needed is a system capable of notifying homeowners of the exact time frame when they should be present for a delivery or service visit, or when they should vacate their home for a schedule real estate agent showing. An application accessible using a mobile computing device which alerts the homeowner when their home is next on an established list using GPS technology, multiple route navigation, push notifications, and a location service feature, combined with instant messaging capabilities of today's mobile devices would suffice.

Heretofore there has not been available a service alert and notification system or method with the advantages and features of the present invention.

### BRIEF SUMMARY OF THE INVENTION

The present invention generally provides a system and method of notifying a homeowner of a more precise timeframe for real estate showings, service visits, or deliveries to a home or office. The system employs a pre-established list which includes all of the locations that must be visited in a day. Instead of providing the homeowner with a multi-hour window of when their residence may be visited, the system will provide the homeowner with updates based upon the GPS location and a location servicing program of the real estate agent, service worker, or delivery person. The system determines which addresses have been visited based upon the GPS coordinates of the agent's mobile computing device and proximity settings, which in turn provides this information to homeowners.

### BRIEF DESCRIPTION OF THE DRAWINGS

The drawings constitute a part of this specification and include exemplary embodiments of the present invention illustrating various objects and features thereof.

FIG. 1 is a diagrammatic representation of various elements included in an embodiment of the present invention.

FIG. 2 is a box diagram illustrating the relationship between various elements included in an embodiment of the present invention.

FIG. 3 is a diagrammatic top plan view of an environment associated with an embodiment of the present invention.

FIG. 4 is a more detailed top plan view of the same.

FIG. 5 is an elevation view of an apparatus interface element of an embodiment of the present invention.

FIG. 6 is a flow chart diagramming a step-by-step method of practicing an embodiment of the present invention.

FIG. 6.1 is a continuation of the same.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, a mobile smart device including a display device for viewing a typical web browser or user interface will be commonly referred to throughout the following description. The type of device, computer, display, or user interface may vary when practicing an embodiment of the present invention. Other examples include the term Agent which refers to a real estate agent or other agent providing services, a Client who may be shown houses by the Agent, and the Seller or Homeowner who owns the building at a specified address where a service will be provided or which will be shown to a Client by an Agent. Further terminology is standard terminology in the field of real estate sales. Said terminology will include the words specifically mentioned, derivatives thereof and words of similar meaning.

### II. General Description of the Invention

The present invention allows a homeowner to be aware of the proximity of a prospective buyer and their agent using mobile communication devices such as smart phones.

The present invention allows the typical two hour window one can expect to be given by a real estate agent or other service delivery agent to be substantially reduced, and the inconvenience could be eliminated entirely. The steps necessary to practice the preferred embodiment of the present invention are as follows.

The first step requires that the sellers meet with seller's agents to list their property. At the listing appointment our application would be discussed with the seller as a way to save time and money.

The second step requires that once the home has been provided a corresponding Multiple Listing Service (MLS) number, the seller would be able to log onto a designated website and provide an alert service database with details on their home, preferred method of contact, and the MLS number corresponding with their residence. Alternatively, this data could be entered into the database manually, either by the seller, the seller's agent, or a person associated with the alert service. At the time of setup, the seller receives a verification email, text alert, and/or other notices insuring that all information they provided is accurate.

The third step requires that the real estate buyer's agents showing the properties have access to the service alert application. One method of access is to download a program onto a mobile smart phone device carried by the buyer's agents. The alert system of the present invention first requires that the agent pre-register on a website associated with the alert system. A security code is then provided to the buyer's agent. This ensures that only licensed real estate professionals are downloading the application and have access to our mapping systems. A similar security system could be used for other service industries, such as delivery persons or home service and repair technicians.

In the example of the real estate field, at time of pre-registration on the website, the buyer's agents would need to provide their identification number given to them by the National Association of Realtors. The service database would automatically preform a “test” application to ensure credentials are accurate. An email verification or other notification will be sent with instructions to obtain the mobile application using the agent's smart phone or other device.

The fourth step requires the real estate agent to compile a list of homes that they and their clients would like to view that day. The list is generated based upon MLS listings only. By doing so, MLS allows the agents to map the houses in order based on location using GPS coordinates and other location services, such as triangulation based upon nearby communications towers as used in the iOS Software Development Kit developed by Apple Inc. of Cupertino, Calif. From that point the agent can either log into the alert system website or manually input the MLS ID's into the mobile application. When either logging onto the system website or manually inputting into the mobile application, the agent is able to manage all of their routes by saving them according to showing dates, names, etc. The application only needs an MLS ID in order to determine the address and route. The alert system also provides a way to map routes simply by using MLS ID numbers, which automatically populate the address and adds it to a mapping route. Other features include allowing a drag-and-click interface, whereby the individual addresses or entries can be selected and moved around on a user interface, to alter the route. All routes can be saved by a custom name and showing date and this data is accessible in real time on the mobile application.

The fifth step requires that once uploading takes place or manual input is entered into the software application, the mobile smart device will save the route under a specified name or date. The client and agent meet to begin looking at homes. This allows agents to save multiple clients routes at a time in case there is no time in between clients.

The sixth step requires that once the agent and client start looking at homes, the agent opens up the specified software application on his/her phone or mobile smart device. Multiple routes may pop up as the agent could have several clients searches saved into their phone. They scroll down to the saved route name that applies to this client and select “Begin Route” or other similar command.

Once the application is started, the position of the agent's mobile device is determined by a GPS connection to known satellites, by triangulating the position based upon nearby cellular communications towers, or by other means. The service alert application alerts all subscribed sellers that the agent and the clients are starting a route that includes their property. The application on the agent's smart phone will determine turn by turn directions to the first property from any starting point. The first seller is alerted via text, email, or other preferred method of contact that the agent is on their way to view their home. Typically, the text notification occurs approximately 15 minutes before the system estimates that the agent will be at the seller's door. The length of time needed for the alert can be adjusted by the seller or the agent. This alert drastically reduces the window time down from present figures. The warned seller then leaves their home. The text is triggered by GPS coordinates that are pre-determined by the driving route at the time of saving in the application. Proximity settings may be altered according to user input, either by the seller or the agent. These settings can be used to determine when the alert is sent, depending on the agent's GPS coordinates at that time.

It should be noted that not all of the sellers on that day's list may have signed up for this application. The present invention would continue the process without alerting the homes that are not subscribed to the system. The sellers would only be provided with their previously estimated window of time through the showing service.

The agent views the first property with their client. Upon pulling up to the property, the Application alerts the agent that they are at the correct property and through push notification asks if they would like to show or skip. Assuming the agent decides to show, the seller receives another text notification that the agent is viewing the property. Upon returning to their vehicle and pulling out of the driveway, the GPS would trigger that the vehicle is moving and would alert the first seller that it is safe to return home. At that time the second seller would be notified that they are en route to their property. The text notification includes the seller's MLS ID number and our programming deciphers which text notification to send. Often times, properties will be viewed in the same neighborhood and often times on the same street. The mapping application would predetermine estimated time travel between the houses. In the event that there is not a sufficient window to alert the second seller, then while viewing the first home that second seller would be alerted that they need to leave their home.

This process is continued throughout the entire route. In the event an agent is running late or early, home owners that have signed up for this application would be alerted prior to their arrival, therefore drastically maximizing the time they are able stay at home. Often, clients may decide not to enter into a home. The application includes a feature allowing agents to automatically notify the sellers if their home was skipped. This can happen at various stages throughout the process. Sometimes agents pull up to a property and for various reasons clients do not want to view it. Other times a route is stopped early and agents and buyers are unable to continue. By ending the application early, all sellers whose properties were not yet viewed would be notified, therefore not ever having to leave. Similarly, the seller may access the system prior to their home's visit and indicate that they wish for their house to be placed later on the list of visits, or to be postponed to another day.

At the end of the day, the agent would be able to print off the route driven which will feature total miles while showing the houses. This feature is handy for tax purposes, as well as for determining whether the most efficient route has been taken.

### III. Preferred Embodiment

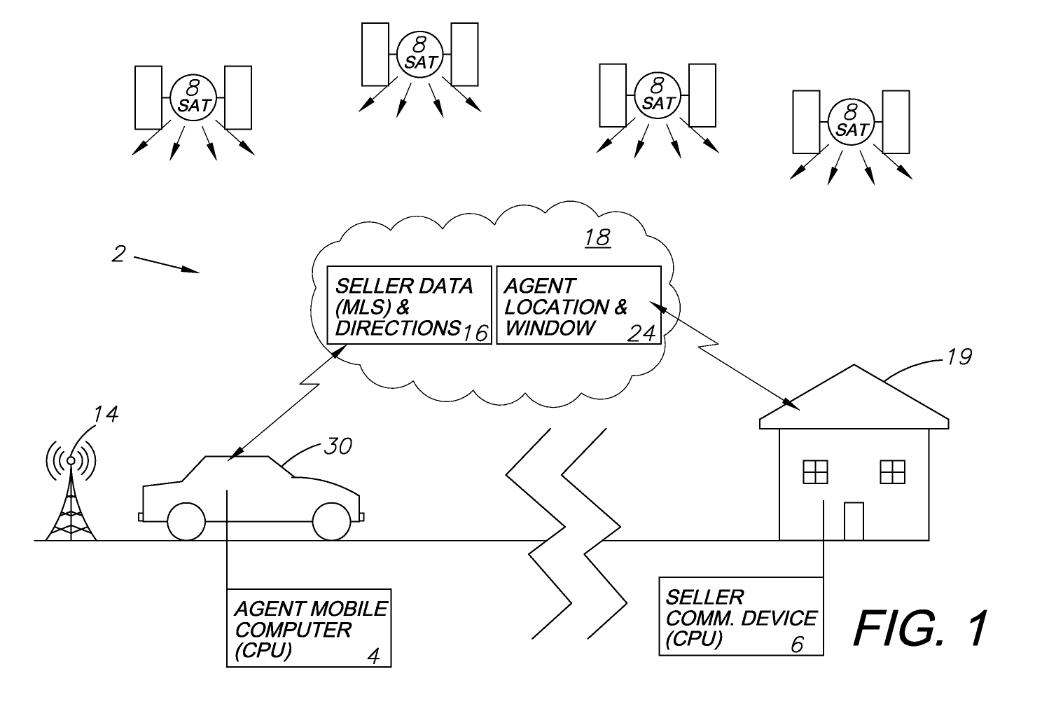

Referring to the figures in more detail, FIG. 1 demonstrates a mobile alert system 2 for use in contacting homeowners when a mobile agent 30 is en route to the homeowner's house 19. Generally the position of the mobile agent 30 is determined by wirelessly locating the mobile agent's mobile computer 4 or communication device, such as a smart phone. This can be done using a standard global positioning system (GPS) which utilizes a plurality of satellites 8 to locate the mobile computer 4, by triangulating the location of the mobile computer using at least three communication towers 14, using wireless networks such as an Wi-Fi connection to the World Wide Web, or by some combination thereof.

A wireless communications network 18, such as a cellular phone network (e.g., Verizon Wireless) allows the mobile agent 30 to use their mobile computer 4 to access information contained on a central server 20 which is central to the mobile alert system 2. As discussed above, in a preferred embodiment this information would comprise a list of MLS numbers associated with home sellers and the addresses of those homes. The mobile agent 30 receives the list of homes to visit on a particular day, and is provided with a turn-by-turn list of directions to the next house on the list. The turn by turn directions populate on the agents phone. This is also referred to the multiple route navigation.

Meanwhile, the seller has a communication device 6 capable of receiving messages, such as SMS text messages, emails, or other communication types. The seller is notified of the mobile agent's location at selected times and locations, as discussed more fully below and as indicated at element 24 of FIG. 1. The seller does not generally have access to a second-by-second location of the mobile agent, but is instead notified after the mobile agent has traveled through some predetermined threshold locations, or has performed some predetermined threshold actions.

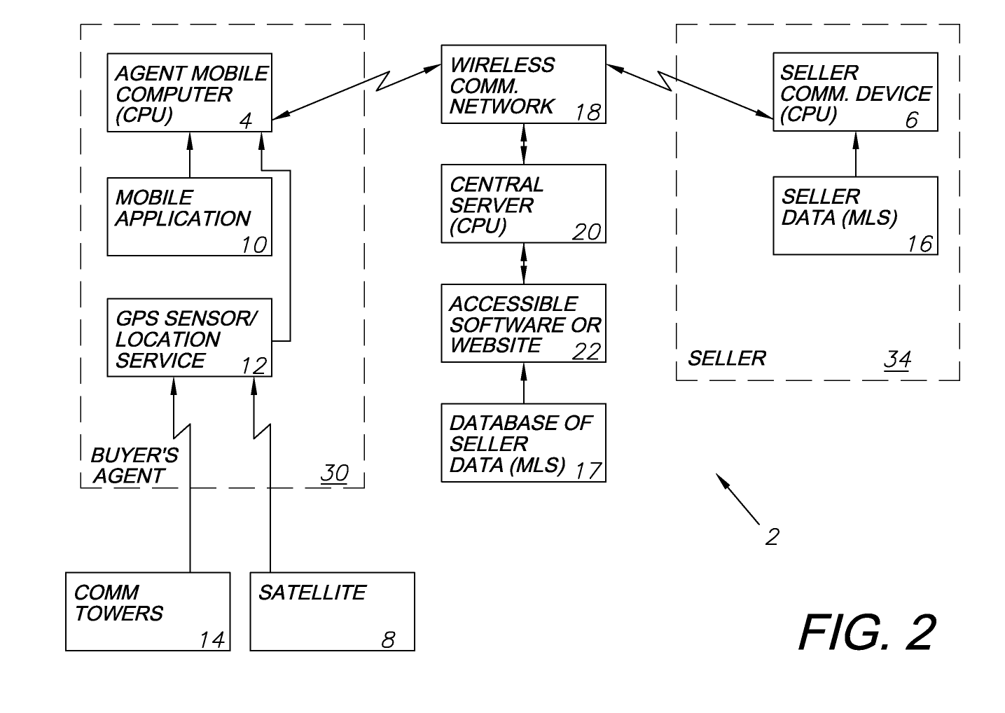

Continuing with the preferred example of a real estate sale scenario, FIG. 2 provides additional detail of the communication channel between the mobile buyer's agent 30, a home seller, and a website containing software 22 enabling the functionality of the mobile alert system 2, being hosted on a centralized server 20 and accessible over a wireless communications network 18.

The key to the preferred embodiment is the seller's data 16, including the seller's MLS number and associated address. This information is tied to the seller's communication device 6, but must also be entered into the website software 22 empowering the mobile alert system 2. The buyer's agent is given turn-by-turn directions to the seller's house based solely upon this address data. A database of seller's data 17, including each MLS number active at that time, is also located on the central server 20. The showing agent never has the seller's contact information throughout this process. All information is privately located on the centralized service alert server.

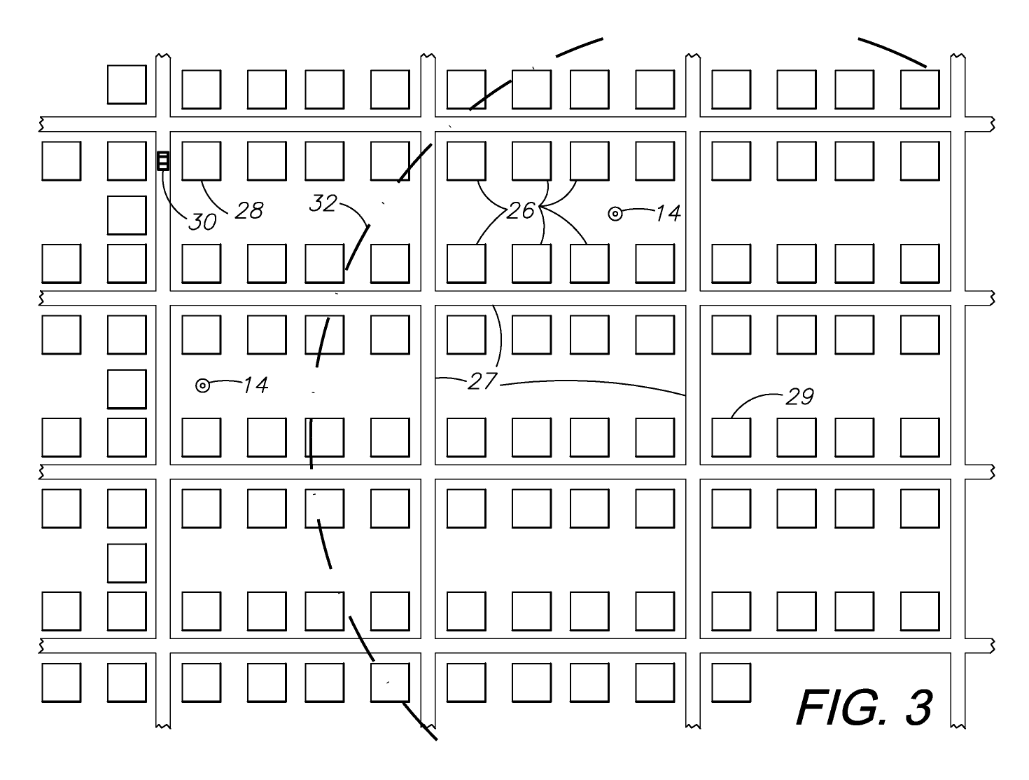

FIG. 3 demonstrates a generic residential neighborhood where a number of houses 26 are located along a number of intersecting streets 27. As the mobile buyer's agent 30 leaves a first seller's house 28, there are two notifications sent. One will go to the seller of the first house 28 alerting that the agent has finished showing the property and they can return home, and the second text alert 24 will be sent to seller of the second house 29 that the mobile agent is en route to their property. This notification is automatically sent when the location service 12 located on the agent's mobile computer 4 detects that the agent has left the first seller's home 28. The notification instructs the first seller that he may return home, and alerts the second seller that the agent is en route.

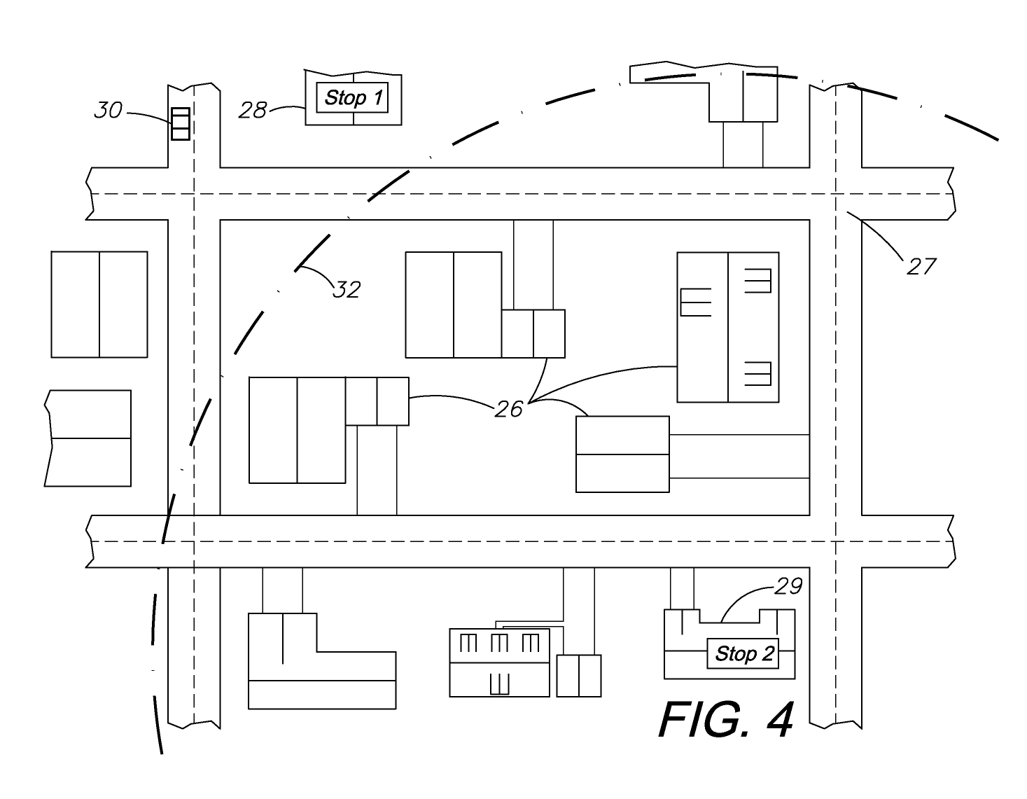

A second notification is sent to the second seller when the mobile agent 30 crosses a threshold distance 32 away from the second seller's home 29. This threshold distance may be arbitrary or it may be established depending on pre-determined distance and travel time allowing that seller ample time to leave the property. In a preferred embodiment, this second notification would be sent to the second seller when the mobile buyer's agent 30 is within fifteen minutes of the second seller's house 29. FIG. 4 shows this process in slightly more detail.

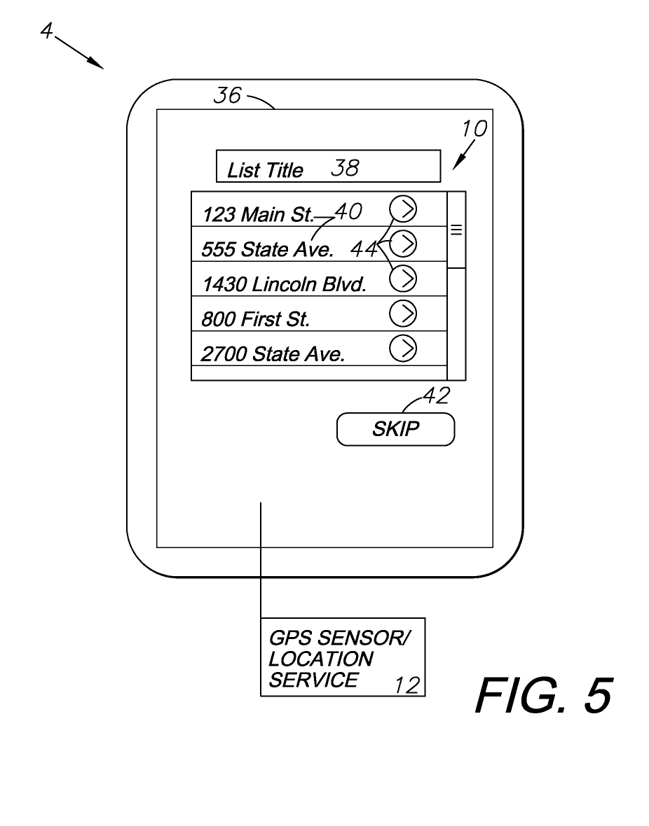

FIG. 5 is a view of the mobile computer 4 possessed by the mobile buyer's agent 30. The device runs a mobile software application 10 which includes at least a customizable list title 38, a list of addresses 40, and a user interface 36 including a touch screen common on modern smart mobile phone devices. A preferred embodiment would also include a plurality of detail buttons 44 which provides the buyer's agent with more information about a selected address 40, such as turn-by-turn directions to that address based on a current location detected by the location service 12, and a “skip” function button 42 which skips the next address on the list.

Other optional features of the mobile application software 10 include the ability to move addresses within the list around by touching the user interface and dragging the address list elements. Another optional feature allows addresses to be removed from the list by swiping a finger across the address at its location within the user interface. An almost unlimited number of actions and features are available for interacting with the mobile application 10 using modern smart phone devices with touch screen interfaces.

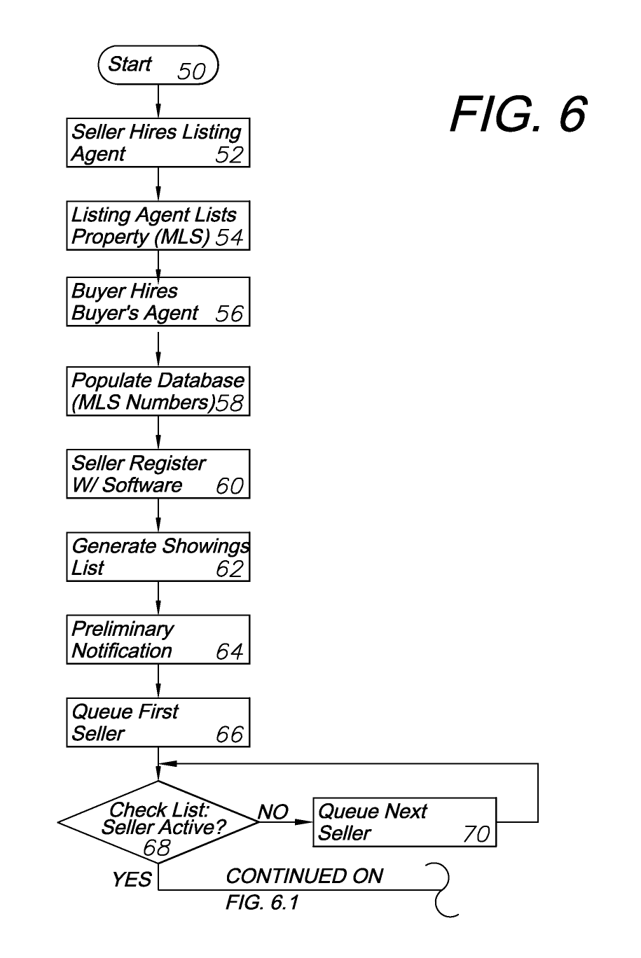

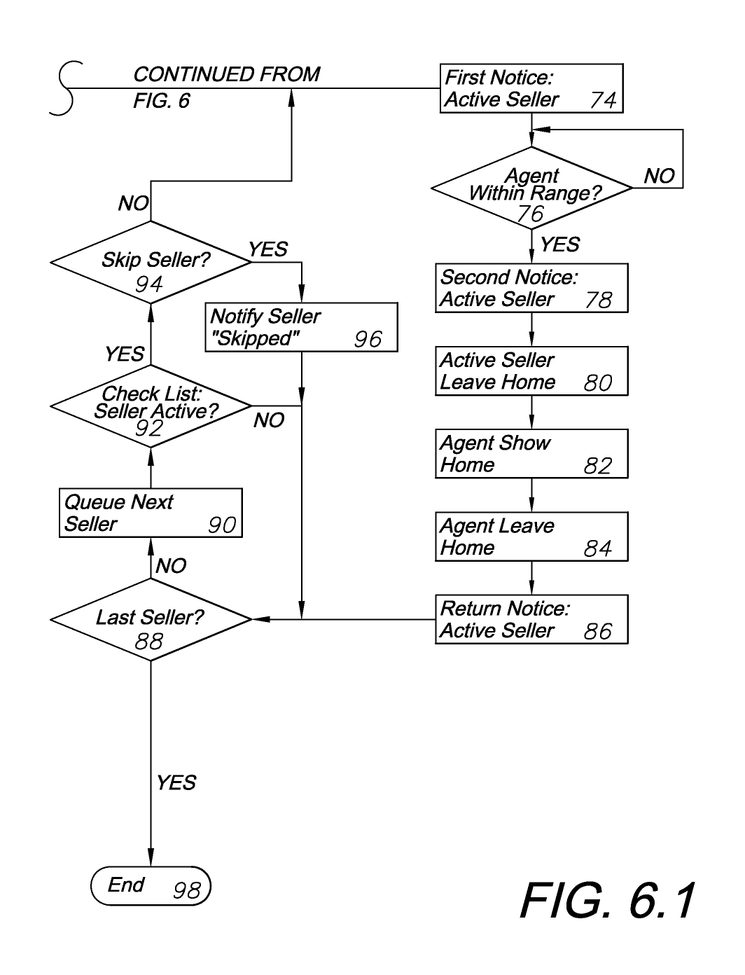

FIG. 6 discloses a preferred method of practicing an embodiment of the present invention, and is continued on FIG. 6.1. The process starts at 50, wherein the entire mobile alert system 2 is already established. A seller hires a listing agent at 52 to list the seller's house for sale, and lists the seller's house on the multiple listing services (MLS) at 54. At some point a buyer hires a buyer's agent at 56.

The system software 22 associated with the mobile alert system 2 populates the database of seller data 17 with every MLS number entered by a seller's listing agent. This occurs at 58. If a seller sells his or her home or takes the home off of the market for any other reason, the seller will no longer have an MLS number. The database is repopulated frequently, updating it with new MLS numbers and removing inactivated numbers.

The seller must register with the system software 22 associated with the mobile alert system 2. This step occurs at 60, and a preferred embodiment requires the seller to access a website located on the World Wide Web containing the system software. This website and software is stored on a localized server as shown in FIG. 2. Once the seller has registered, his or her MLS number will be obtainable using the mobile alert software 2 from a buyer's agent's mobile device 4 with the mobile version of the software 10.

A list of showings is generated for the buyer's agent at 62. This includes a number of MLS numbers and the addresses associated with those numbers. The buyer's agent may generate the list themselves by selecting a number of MLS numbers and/or addresses from those active, or the list may be generated randomly by the system server's 20 CPU. A preliminary notice is sent to all sellers whose information is contained on the buyer's agent's list on that day at 64. This notice may provide an estimated visitation window when the buyer's agent expects to be showing that particular seller's home, or it may simply notify the seller that their home will be shown at some point that day.

The mobile software 10 then queues the first seller on the list at 66. The mobile device 4 double checks the MLS number or other seller data to determine that the seller is still active at 68. This means that the system once again checks to make sure the seller is still interested in selling their home, has not yet sold their home, and has not yet removed their home from the MLS. There may be an option for the seller to opt out of his or her house being shown that particular day, so the system also checks to determine that the seller hasn't opted out in such a way.

If the check at 68 determines that the seller is no longer active for any of the reasons mentioned above, the system will queue the next seller in the list at 70, and that seller is checked to determine if they remain active. Otherwise a notification is sent to the active seller at 74 to let them know that the buyer's agent is en route to the active seller's home.

A boundary 32 is determined based upon the buyer's geospatial location, and constant check is performed to determine whether the buyer's agent is within that boundary at 76. This boundary provides the seller with a very small window of time for when the buyer's agent will be at his or her home. Once the range check at 76 determines that the agent is within a certain distance of the active seller's home, a second notification is sent to the active seller at 78. This indicates to the seller that they should leave their home within the next several minutes to allow the buyer's agent to show the home. The seller leaves the home at 80, and the agent shows the home at 82.

Once the agent is done showing the home at 82, the agent will leave the home at 84. The location system 12 detects that the agent is no longer at the seller's home and will notify the seller that they may return home at their convenience at 86. The system then checks to determine if there are any remaining sellers on the list at 88. If there are not, the process ends by alerting the agent the route is complete and the agent returns to his or her office. If there are remaining sellers on the list, then the next seller is queued up at 90.

As before, a check is performed to determine if the seller is active at 92. If the seller is not active, then the next seller in the list, if any, is queued up. Once an active seller is found the agent is provided with the option to skip that seller at 94. This skip option may be performed for several reasons, such as at the request of the seller or due to time constraints for the buyer or the buyer's agent. The seller is notified if skipped at 96, and the next seller is queued up, if any.

Once an active seller is found and not skipped, that seller is provided with a first notice at 74, and the process repeats until the entire list is completed at 98.

At any time a seller may register with the website software 22 and may be added to a buyer's agent's list. However, in a typical situation the seller will have registered with the software 22 prior to the date of the visit by the buyer's agent.

At any time after receiving a preliminary notification from a buyer's agent, a seller may access the website software to request being skipped that day, or may respond to the buyer's agent with such a request.

At any time the buyer's agent may reorganized their list or otherwise update the list. At that time, an alert may be sent out to all sellers on the list of the change in schedule.

Buyer's agents' lists are saved and may be accessed at a later date. The archived information may include miles driven, time spent at each residence, or other valuable data. This data would also be useful for tax preparation purposes.

It is to be understood that while certain embodiments and/or aspects of the invention have been shown and described, the invention is not limited thereto and encompasses various other embodiments and aspects.

Having this described the invention, what is claimed as new and desired to be secured by Letters Patent is:

1. A computer-implemented method, comprising the steps:
receiving in a computing device location data input by a recipient;
providing a user with a first mobile device;
transferring from said computing device a mobile application to said first mobile device;
receiving in said computing device a request from said first mobile device, in response to the user selecting a user interface element within said mobile application executed separately from a browser application on the first mobile device, the user interface element being pre-associated with a service for locating an address based upon said location data;
in response to the request, generating a list of directions from a current location associated with said first mobile device to an address associated with said location data; and
simultaneously providing by the computing device a first alert notification to said recipient indicating a window of time during which said user will arrive at the address associated with said location data, wherein said window of time is computed by said computing device based upon the current location associated with said first mobile device and said address associated with said location data.

2. The method according to claim 1, wherein said computing device includes a data storage medium and a processor.

3. The method according to claim 2, further comprising:
providing said recipient with a second mobile device; and
receiving said first alert notification with said second mobile device.

4. The method according to claim 3, wherein time data associated with the time at which said first notification is sent is stored within said computing device data storage medium.

5. The method according to claim 4, further comprising the steps:
monitoring with said computing device the location of said first mobile device; and
storing time data associated with the time at which said first mobile device arrives at the address associated with said location data within said computing device data storage medium.

6. The method according to claim 5, further comprising the steps:
storing time data associated with the time at which said first mobile device departs the address associated with said location data within said computing device data storage medium;
providing by the computing device a second alert notification to said recipient indicating that said user is no longer located at the address associated with said location data, based upon the current location associated with said first mobile device and said address associated with said location data; and
receiving said second alert notification with said second mobile device.

7. The method according to claim 1, wherein a security code is required by said computing device prior to transferring said mobile application to said first mobile device.

8. The method according to claim 7, wherein:
said location data represents real estate data associated with a multiple listing service identification number;
said user is a real estate agent identified by a real estate agent identification number; and
wherein said security code is generated by said computing device based upon said real estate identification number.

9. The method according to claim 7, wherein:
said location data represents client information associated with a work order with a work order number;
said user is a service worker with access to said work order; and
said security code is generated based upon said work order number.

10. A computer-implemented method, comprising the steps:
receiving in a computing device location data input by a plurality of recipients, said computing device including a data storage medium and a processor;
providing each of said plurality of recipients with a recipient mobile device;
providing a user with a user mobile device and a user identification number;
providing from said computing device to said user mobile device a security code associated with said user identification number;
transferring from said computing device a mobile application to said user mobile device;
generating with said computing device a list of addresses based upon said location data;
receiving in said computing device a request from said user mobile device, in response to the user selecting a user interface element within said mobile application executed separately from a browser application on the first mobile device, the user interface element being pre-associated with a service for a locating said list of addresses;
in response to the request, providing by the computing device to the user mobile device a list of directions from a current location associated with said user mobile device to an address selected from said list of addresses;
computing with said computing device a window of time during which said user will arrive at the selected address, said window of time calculated based upon the current location associated with said first mobile device and said address associated with said location data;
providing by the computing device a first alert notification to the recipient associated with the address selected from said list of addresses, whereby said first notification identifies said window of time to said recipient; and
receiving said first alert notification with the recipient mobile device associated with the recipient associated with the address selected from said list of addresses.

11. The method according to claim 10, further comprising the steps:
monitoring with said computing device the location of said user mobile device; and
storing time data associated with the time at which said user mobile device arrives at the selected address within said computing device data storage medium.

12. The method according to claim 11, further comprising the steps:
storing time data associated with the time at which said first mobile device departs the selected address within said computing device data storage medium;
providing by the computing device a second alert notification to the recipient associated with the selected address, said second alert notification indicating that said user is no longer located at the selected address, based upon the current location associated with said first mobile device and said address associated with said location data; and
receiving said second alert notification with the recipient mobile device associated with the recipient associated with the address selected from said list of addresses.

13. The method according to claim 12, wherein:
said location data represents real estate data associated with a multiple listing service identification number;
said user identification number is a real estate agent identification number; and
wherein said security code is generated by said computing device based upon said real estate identification number.

14. The method according to claim 12, wherein:
said location data represents client information associated with a work order;
said identification number is a work order number associated with said work order;
said user is a service worker with access to said work order; and
said security code is generated based upon said work order number.

15. A system for notifying a recipient, the system comprising:
a computing device including a data storage medium and a processor;
a user having a first mobile device and a user identification number;
a recipient having a second mobile device;
a mobile application received by said first mobile device from said computing device;
location data associated with said recipient, said location data including an address;
wherein said mobile application is executed separately from a browser application on the first mobile device;
wherein said mobile application includes a user interface element being pre-associated with a service for a the address associated with said location data;
a list of directions from a current location associated with said user mobile device to an address selected from said list of addresses generated by said computing device and wirelessly communicated to said first mobile device;
a window of time calculated by said computing device, said window of time indicating when said user will arrive at the selected address, said window of time calculated based upon the current location associated with said first mobile device and said address associated with said location data; and
a first alert notification sent by said computing device to said second mobile device, whereby said first notification identifies said window of time to said recipient.

16. The system according to claim 15, wherein said computing device constantly monitors said the location of said first mobile device, the system further comprising:
time data associated with the time at which said first mobile device arrives at the address associated with said location data, said time data being stored within said computing device data storage medium.

17. The system according to claim 16, further comprising:
time data associated with the time at which said first mobile device departs the address associated with said location data within, said time data being stored within computing device data storage medium; and
a second alert notification sent by said computing device to said second mobile device, whereby said second alert notification indicates that said user is no longer located at the address associated with said location data, based upon the current location associated with said first mobile device and said address associated with said location data.

18. The method according to claim 15, wherein a security code is required by said computing device prior to transferring said mobile application to said first mobile device.

19. The method according to claim 18, wherein:
said location data represents real estate data associated with a multiple listing service identification number;
said user is a real estate agent identified by a real estate agent identification number; and
wherein said security code is generated by said computing device based upon said real estate identification number.

20. The method according to claim 18 wherein:
said location data represents client information associated with a work order with a work order number;
said user is a service worker with access to said work order; and
said security code is generated based upon said work order number.
